(19) United States
(12) Patent Application Publication
(10) Pub. No.: US 2023/0140479 A1
(43) Pub. Date: May 4, 2023

(54) TONER

(71) Applicant: KYOCERA Document Solutions Inc., Osaka (JP)

(72) Inventor: Seiji KIKUSHIMA, Osaka-shi (JP)

(73) Assignee: KYOCERA Document Solutions Inc., Osaka (JP)

(21) Appl. No.: 18/049,726

(22) Filed: Oct. 26, 2022

(30) Foreign Application Priority Data
Oct. 28, 2021 (JP) 2021-176542

(51) Int. Cl. G03G 9/08; G03G 9/083; G03G 9/087

(52) U.S. Cl. CPC G03G 9/0825; G03G 9/0821; G03G 9/0833; G03G 9/0838; G03G 9/08711; G03G 9/08755; G03G 9/0839

(57) ABSTRACT

A toner includes toner particles. The toner particles each include a toner mother particle and an external additive provided on the surface of the toner mother particle. The toner mother particles contain a binder resin and a magnetic powder. The external additive includes alumina particles. The alumina particles have a number average primary particle diameter of at least 150 nm and no greater than 400 nm. The toner has a time constant of at least 1.0 seconds and no greater than 10.0 seconds. A sediment has a zeta potential at pH 2 of at least 0.0 mV and no greater than 20.0 mV. The sediment is obtained by separation from a dispersion of the toner.

### INCORPORATION BY REFERENCE

The present application claims priority under 35 U.S.C. § 119 to Japanese Patent Application No. 2021-176542, filed on Oct. 28, 2021. The contents of this application are incorporated herein by reference in their entirety.

### BACKGROUND

The present disclosure relates to a toner.

Electrophotographic image formation uses a toner including toner particles. The toner particles each include a toner mother particle and an external additive attached to the surface of the toner mother particle, for example. For example, a magnetic toner is known that includes a first external additive, a second external additive, and magnetic toner mother particles containing a binder resin and a magnet. The absolute value |ζK(T)−ζ(A1)| of a difference between the zeta potential ζ(T) of the magnetic toner particles when the magnetic toner particles are dispersed in water and the zeta potential ζ(A1) of the first external additive when the first external additive is dispersed in water is no greater than 50 mV.

### SUMMARY

A toner according to an aspect of the present disclosure includes toner particles. The toner particles each include a toner mother particle and an external additive provided on a surface of the toner mother particle. The toner mother particles contain a binder resin and a magnetic powder. The external additive includes alumina particles. The alumina particles have a number average primary particle diameter of at least 150 nm and no greater than 400 nm. The toner has a time constant of at least 1.0 seconds and no greater than 10.0 seconds. A sediment has a zeta potential at pH 2 of at least 0.0 mV and no greater than 20.0 mV. The sediment is obtained by separation from a dispersion of the toner.

### DETAILED DESCRIPTION

The following describes a preferred embodiment of the present disclosure. The terms used in the present specification will be explained first. A toner refers to a collection (e.g., a powder) of toner particles. An external additive refers to a collection (e.g., a powder) of external additive particles. A magnetic powder is a collection (powder) of magnetic particles. Evaluation results (values indicating for example shapes or properties) for a powder (specific examples include a powder of toner particles and a powder of external additive particles) each are a number average of values as measured with respect to a suitable number of particles selected from the powder unless otherwise stated.

Values for volume median diameter (D50) of a powder are values as measured based on the Coulter principle (electrical sensing zone technique) using “Coulter Counter Multisizer 3” produced by Beckman Coulter, Inc. unless otherwise stated.

Unless otherwise stated, a number average primary particle diameter of a powder is a number average value of equivalent circle diameters (Heywood diameters: diameters of circles having the same areas as projected areas of respective primary particles) of primary particles of the powder as measured using a scanning electron microscope. The number average primary particle diameter of a powder is a number average value of equivalent circle diameters of for example 100 primary particles of the powder. Note that a number average primary particle diameter of a powder indicates a number average primary particle diameter of particles of the powder unless otherwise stated.

Chargeability refers to chargeability in triboelectric charging unless otherwise stated. The level of positive chargeability (or the level of negative chargeability) in triboelectric charging can be determined by a known triboelectric series, for example.

Values for a softening point (Tm) are values as measured using a capillary rheometer (“CFT-500D”, product of Shimadzu Corporation) unless otherwise stated. On an S-shaped curve (horizontal axis: temperature, vertical axis: stroke) plotted using the capillary rheometer, the softening point (Tm) corresponds to a temperature corresponding to a value of “((base line stroke value)+(maximum stroke value))/2”.

Values for a glass transition point (Tg) are values as measured in accordance with “the Japanese Industrial Standards (JIS) K7121-2012” using a differential scanning calorimeter (“DSC-6220”, product of Seiko Instruments Inc.) unless otherwise stated. On a heat absorption curve (vertical axis: heat flow (DSC signal), horizontal axis: temperature) plotted using the differential scanning calorimeter, the glass transition point (Tg) corresponds to a temperature (specifically, temperature at an intersection point of an extrapolation line of a base line and an extrapolation line of a falling portion of the curve) at a point of inflection resulting from glass transition.

Unless otherwise stated, values for an acid value are values as measured in accordance with “the Japanese Industrial Standards (JIS) K0070-1992”.

A mass average molecular weight (Mw) refers to a value as measured using a gel permeation chromatography unless otherwise stated.

An electrical resistivity refers to an electric resistance as measured using an electric resistance meter (“R6561”, product of ADVANTEST CORPORATION) in an environment at a temperature of 25° C. and a relative humidity of 50% unless otherwise stated.

Unless otherwise stated, a “main component” of a material refers to a component the most abundant in the material in terms of mass.

The level of hydrophobicity (or the level of hydrophilicity) can be represented by a contact angel (wettability of water) of a water droplet, for example. The larger the contact angle of a water droplet is, the higher the hydrophobicity is. Hydrophobization treatment refers to treatment for increasing hydrophobicity. Hydrophilization treatment refers to treatment for increasing hydrophilicity.

In the following description, the term “-based” may be appended to the name of a chemical compound to form a generic name encompassing both the chemical compound itself and derivatives thereof. Also, when the term “-based” is appended to the name of a chemical compound used in the name of a polymer, the term indicates that a repeating unit of the polymer originates from the chemical compound or a derivative thereof.

The term “(meth)acryl” is used as a generic term for both acryl and methacryl. The term “(meth)acrylate” is used as a generic term for both acrylate and methacrylate. The term “(meth)acrylonitrile” is used as a generic term for both acrylonitrile and methacrylonitrile. An alkyl group is an unsubstituted straight chain or branched chain alkyl group unless otherwise stated. The words “each represent, independently of one another,” in description of a formula mean representing the same group or different groups. Note that one type of each component described in the following description may be used independently or two or more types of the component may be used in combination unless otherwise stated. The terms used in the present specification have been explained so far.

<Toner>

A toner according to the present embodiment includes toner particles. The toner particles each include a toner mother particle and an external additive. The external additive is provided on the surface of the toner mother particle. The toner mother particles contain a binder resin and a magnetic powder. The external additive includes alumina particles. The alumina particles have a number average primary particle diameter of at least 150 nm and no greater than 400 nm. The toner has a time constant (τ) of at least 1.0 seconds and no greater than 10.0 seconds. A sediment obtained by separation from a dispersion of the toner has a zeta potential at pH 2 of at least 0.0 mV and no greater than 20.0 mV.

In the following, the “zeta potential at pH 2 of a sediment obtained by separation from a dispersion of the toner”, a “zeta potential at pH 5 of a sediment obtained by separation from a dispersion of the toner”, which will be described later, a “zeta potential at pH 2 of a supernatant obtained by separation from the dispersion of the toner”, which will be described later, and a “zeta potential at pH 5 of a supernatant obtained by separation from the dispersion of the toner”, which will be described later, may be respectively referred to as “zeta potential (D-pH2)”, “zeta potential (D-pH5)”, “zeta potential (U-pH2)”, and “zeta potential (U-pH5)”. Furthermore, a “sediment obtained by separation from a dispersion of the toner” and a “supernatant separated from a dispersion of the toner” may be referred to simply as “sediment” and “supernatant”, respectively.

As a result of having the above features, the toner according to the present embodiment can form images with desired image density and less fogging even in printing on many sheets. The reasons therefor are inferred as follows.

Explanation will be made below using an image forming apparatus including a development roller and a toner charging member as an example. A toner layer is formed on the circumferential surface of the development roller (specifically, the circumferential surface of a development sleeve). First, a mechanism by which the toner layer formed on the development sleeve is charged will be described. Toner particles forming the toner layer on the development sleeve are charged by friction with a toner charging member (e.g., a blade). Thereafter, charge transfers from the charged toner particles to adjacent other toner particles with a result that all the toner particles included in the toner layer are charged. The transfer rate of the charge in the toner layer tends to depend on the time constant of the toner (product of electric resistance and permittivity of the toner). Specifically, a toner layer formed with a toner with a small time constant has a high transfer rate of charge and the charge amount distribution of the toner tends to be narrow. When the charge amount distribution of the toner included in the toner layer is narrow, developability of the toner is increased, thereby achieving formation of images with desired image density. However, in a toner layer formed with a toner with an excessively small time constant, charge moves through the toner to the development sleeve to reduce the amount of charge (charge relaxation) to less than a desired value, tending to form an extremely thin toner layer. Such an extremely thin toner layer decreases developability of the toner.

Here, the toner of the present embodiment has a time constant of at least 1.0 seconds and no greater than 10.0 seconds. As a result of the time constant of the toner being set to at least 1.0 seconds, charge hardly moves through the toner to the development sleeve and the amount of charge of the toner hardly reduces to less than a desired value (charge relaxation). As a result, images with less fogging can be formed. When the time constant of the toner is no greater than 10.0 seconds by contrast, the transfer rate of charge in the toner layer can be kept high even in printing on many sheets, thereby narrowing the charge amount distribution of the toner. When the charge amount distribution of the toner included in the toner layer is narrow, developability of the toner is increased, thereby achieving formation of images with desired image density even in printing on many sheets.

Furthermore, when the zeta potential (D-pH2) is at least 0.0 mV, chargeability of the toner is increased and the toner layer formed on the development sleeve is not excessively thin even in printing on many sheets. As a result, images with desired image density can be formed even in printing on many sheets. When the zeta potential (D-pH2) is no greater than 20.0 mV by contrast, images with desired image density and less fogging can be formed even in printing on many sheets.

Furthermore, when the alumina particles have a number average primary particle diameter of at least 150 nm and no greater than 400 nm, separation of the alumina particles from the toner mother particles is inhibited, with a result that images with desired density can be formed even in printing on many sheets. The reasons why images with desired image density and less fogging can be formed even in printing on many sheets have been explained so far.

The toner according to the present embodiment can be favorably used as for example a positively chargeable magnetic toner (one-component developer) for development of electrostatic latent images. The following describes the time constant of the toner of the present embodiment and the zeta potentials of a sediment and a supernatant. The external additive and the toner mother particles of the toner according to the present embodiment will also be described.

[Time Constant]

As described previously, the toner has a time constant of at least 1.0 seconds and no greater than 10.0 seconds. In the present specification, the time constant of the toner is a value as measured in an environment at a temperature of 20° C. and a relative humidity of 65%. In order to form images with desired image density and less fogging even in printing on many sheets, the time constant of the toner is preferably at least 1.5 seconds and no greater than 6.0 seconds. The time constant of the toner is measured by a method described in association with Examples or a method based thereon. The time constant of the toner is adjusted by changing a ratio of the total mass of tin and antimony in a conductive metal oxide contained in conductive layers to the mass of bases in the alumina particles serving as an external additive.

[Zeta Potential]

The zeta potential of a sediment is an indicator indicating chargeability of a toner. As the zeta potential of the sediment is increased, chargeability of the toner tends to increase. By contrast, the zeta potential of a supernatant is affected by the external additive free from the toner mother particles.

In the present specification, the zeta potentials of the sediment and the supernatant are values as measured in an environment at a temperature of 20° C. A method for measuring the zeta potentials of the sediment and the supernatant will be described briefly. First, 20 mg of the toner is dispersed in 2 mL of a surfactant aqueous solution to obtain a dispersion of the toner. The surfactant aqueous solution is a 10% by mass-concentration aqueous solution of a nonionic surfactant with an HLB value of 15.3. The dispersion of the toner is diluted 50 times with ion exchange water to obtain a diluted dispersion of the toner. Magnetic separation is performed on the diluted dispersion of the toner using a neodymium magnet with a residual magnetic flux density of 1.25 T. Then, a sediment attracted to the magnet and a supernatant not attracted to the magnet are obtained. The zeta potentials of the resultant sediment and supernatant are measured using a laser Doppler zeta potential analyzer. The method for measuring the zeta potentials of the sediment and the supernatant has been briefly described. A specific method for measuring the zeta potentials of the sediment and the supernatant will be described later in Examples.

As describe previously, the zeta potential (D-pH2) is at least 0.0 mV and no greater than 20.0 mV. In order to form images with desired image density and less fogging, the zeta potential (D-pH2) is preferably at least 5.0 mV and no greater than 15.0 mV. The zeta potential (D-pH2) is adjusted by changing the type of a surfactant used for surface treatment of the alumina particles serving as an external additive, for example.

In order to form images with desired image density and less fogging, the zeta potential (D-pH5) is preferably at least −60.0 mV and less than 0.0 mV. Control of the zeta potential (D-pH5) together with the zeta potential (D-pH2) can favorably control chargeability of the toner. The zeta potential (D-pH5) is adjusted by the same method as that for adjusting the zeta potential (D-pH2), for example.

From the viewpoint of adjustment of the zeta potential (D-pH2) and the zeta potential (U-pH2) to the same level, the zeta potential (U-pH2) is at least 0.0 mV and no greater than 20.0 mV, for example. From the viewpoint of adjustment of the zeta potential (D-pH5) and the zeta potential (U-pH5) to the same level, the zeta potential (U-pH5) is at least −60.0 mV and less than 0.0 mV, for example. The zeta potential (U-pH2) and the zeta potential (U-pH5) each are adjusted by changing the amount of a conductive treatment agent used in conductive treatment of the alumina particles serving as an external additive and the type of a surface treatment agent used in surface treatment of the alumina particles, for example.

The half-width of the zeta potential of the sediment obtained by separation from the dispersion of the toner serves as an indicator indicating how many external additives are contained in the toner. The half-width of the sediment tends to increase as the number of the external additives provided for the toner mother particles is increased. In order to form images with desired image density and less fogging, the half-width of the zeta potential (D-pH2) is preferably at least 0.0 mV and no greater than 30.0 mV, and more preferably at least 20.0 mV and no greater than 30.0 mV. For the same purpose as above, the half-width of the zeta potential (D-pH5) is preferably at least 0.0 mV and no greater than 30.0 mV, and more preferably at least 20.0 mV and no greater than 30.0 mV. From the viewpoint of adjustment of the half-width of the zeta potential (D-pH2) and the half-width of the zeta potential (U-pH2) to the same level, the half-width of the zeta potential (U-pH2) is preferably at least 0.0 mV and no greater than 30.0 mV, and more preferably at least 20.0 mV and no greater than 30.0 mV. From the viewpoint of adjustment of the half-width of the zeta potential (D-pH5) and the half-width of the zeta potential (U-pH5) to the same level, the half-width of the zeta potential (U-pH5) is preferably at least 0.0 mV and no greater than 30.0 mV, and more preferably at least 20.0 mV and no greater than 30.0 mV.

[External Additive]

The external additive includes the alumina particles. Preferably, the external additive further includes organic particles in addition to the alumina particles. The external additive may further include silica particles as necessary. The external additive may further include external additive particles (also referred to below as additional external additive particles) other than the alumina particles, the organic particles, and the silica particles.

<Alumina Particles>

The alumina particles tend to have a zeta potential close to the zeta potential of the magnetic powder contained in the toner mother particles. A toner including alumina particles with a zeta potential close to that of a magnetic powder tends to have a narrow charge amount distribution. The narrow charge amount distribution of the toner increases developability of the toner to achieve formation of images with desired image density even in printing on many sheets.

As described previously, the alumina particles have a number average primary particle diameter of at least 150 nm and no greater than 400 nm. In order to form images with desired image density even in printing on many sheets, the alumina particles preferably have a number average primary particle diameter of at least 250 nm and no greater than 350 nm.

The amount of the alumina particles is preferably at least 1 part by mass and no greater than 100 parts by mass relative to 1000 parts by mass of the toner mother particles, and more preferably at least 1 part by mass and no greater than 20 parts by mass. The amount of the alumina particles is preferably at least 30 parts by mass and no greater than 60 parts by mass relative to 100 parts by mass of the external additive, and more preferably at least 40 parts by mass and no greater than 50 parts by mass. In a case in which the external additive includes silica particles in addition to the alumina particles, the amount of the alumina particles is preferably at least 0.5 parts by mass and no greater than 1.5 parts by mass relative to 1.0 parts by mass of the silica particles.

Preferably, the alumina particles each include a base, a conductive layer, and a surface treatment layer. The conductive layer covers the base. The surface treatment layer covers the conductive layer. Of the two layers covering the base, the conductive layer is an inside layer (beside the base) and the surface treatment layer is an outside layer. The following describes the bases, the conductive layers, and the surface treatment layers.

(Bases)

The bases contain alumina. The alumina particles tend to exhibit positive chargeability. As such, the toner including the alumina particles is easy to be positively charged. The percentage content of the alumina in the bases is preferably at least 80% by mass, more preferably at least 95% by mass, and further preferably 100% by mass.

(Conductive Layers)

The conductive layers are layers formed from a conductive treatment agent. As a result of the alumina particles, which serve as an external additive, including the conductive layers, the toner can have moderately low electric resistance. Therefore, the time constant of the toner (product of electric resistance and permittivity of the toner) can be easily adjusted within the specific range.

The conductive layers preferably contain an oxide with conductivity, and more preferably contain a metal oxide (also referred to below as conductive metal oxide) with conductivity. Examples of the conductive metal oxide include metal oxides (e.g., antimony tin oxide (ATO), indium tin oxide (ITO), and fluorine tin oxide (FTO)) containing tin oxide, and metal oxides (e.g., aluminum zinc oxide (AZO) and gallium zinc oxide (GZO)) containing zinc oxide. The conductive layers preferably contain antimony tin oxide. The percentage content of the conductive metal oxide in the conductive layers is preferably at least 80% by mass, more preferably at least 95% by mass, and further preferably 100% by mass.

In terms of easy adjustment of the time constant of the toner within the specific range, the conductive metal oxide contained in the conductive layers preferably contains tin and antimony. In terms of easy adjustment of the time constant of the toner within the specific range, the total mass of the zinc and the antimony in the conductive metal oxide contained in the conductive layers is preferably at least 10.0 parts by mass and no greater than 50.0 parts by mass relative to 100.0 parts by mass of the bases, and more preferably at least 12.5 parts by mass and no greater than 26.0 parts by mass.

In terms of easy adjustment of the time constant of the toner within the specific range, a ratio (MSn/MSb) of a mass (MSn) of the tin to a mass (MSb) of the antimony in the conductive metal oxide contained in the conductive layers is preferably at least 0.10 and no greater than 0.50, and more preferably at least 0.20 and no greater than 0.40.

(Surface Treatment Layers)

The surface treatment layers are layers formed from a surface treatment agent. The surface treatment layers impart favorable charge stability to the toner while inhibiting peeling off of the conductive layers. The surface treatment agent is a hydrophobizing agent, for example. Specific examples of the surface treatment agent include titanate coupling agents, aluminate coupling agents, and fatty acid metal salt. In terms of easy adjustment of the zeta potential (D-pH2) within the specific range, the surface treatment agent is preferably a titanate coupling agent or an aluminate coupling agent.

Examples of the titanate coupling agents include isopropyl trialkanoyl titanate, isopropyltris(dioctylpyrophosphate)titanate, isopropyltri(N-aminoethyl-aminoethyl)titanate, tetraoctylbis(ditridecylphosphite)titanate, isopropyl trioctanoyl titanate, isopropyldimethacryl isostearoyl titanate, isopropyl tridodecylbenzenesulfonyl titanate, isopropyl isostearoyl diacryl titanate, and isopropyl tri(dioctylphosphate)titanate. The titanate coupling agent is preferably isopropyl trialkanoyl titanate, and more preferably isopropyl triisostearoyl titanate. Isopropyl trialkanoyl titanate is represented by formula (1).

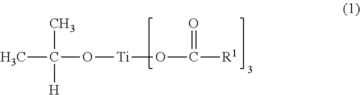

In formula (1), R¹ represents an alkyl group. The alkyl group represented by R¹ is preferably an alkyl group with a carbon number of at least 3 and no greater than 30, more preferably an alkyl group with a carbon number of at least 15 and no greater than 20, and further preferably an alkyl group with a carbon number of 17. Where R¹ represents an alkyl group with a carbon number of 17, the compound represented by formula (1) is isopropyltriisostearoyl titanate.

Examples of the aluminate coupling agents include aluminum ethylate, aluminum isopropylate, aluminum alkylacetoacetate dialkylate, mono sec-butoxyaluminum diisopropylate, aluminum sec-butyrate, aluminum tris(ethylacetoacetate), aluminum monoacetyl acetonate bis(ethylacetoacetate), aluminum tris(acetylacetonate), cyclic aluminum oxide isopropylate, and cyclic aluminum oxide isostearate. The aluminate coupling agent is preferably aluminum alkyl acetoacetate dialkylate, and more preferably aluminum alkyl acetoacetate diisporopylate. Aluminum alkyl acetoacetate dialkylate is represented by formula (2).

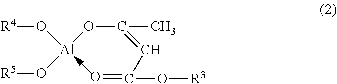

In formula (2), R³, R⁴, and R⁵ each represent, independently of one another, an alkyl group. The alkyl group represented by R³ is preferably an alkyl group with a carbon number of at least 8 and no greater than 30, more preferably an alkyl group with a carbon number of at least 15 and no greater than 20, and further preferably an alkyl group with a carbon number of 18. The alkyl groups represented by R⁴ and R⁵ each represent, independently of one another, preferably an alkyl group with a carbon number of at least 1 and no greater than 6, more preferably an alkyl group with a carbon number of at least 2 and no greater than 4, further preferably an alkyl group with a carbon number of 3, and particularly preferably an isopropyl group. Where R⁴ and R⁵ each represent an isopropyl group, the compound represented by formula (2) is aluminum alkyl acetoacetate diisporopylate.

In terms of easy adjustment of the zeta potential (D-pH2) within the specific range, the surface treatment layers are preferably titanate coupling agent treatment layers or aluminate coupling agent treatment layers. That is, the surface treatment layers preferably contain a component derived from a titanate coupling agent or a component derived from an aluminate coupling agent.

The mass of the surface treatment layers is preferably at least 1 part by mass and no greater than 100 parts by mass relative to 100 parts by mass of the bases, and more preferably at least 1 part by mass and no greater than 10 parts by mass. As a result of the mass of the surface treatment layers being within a range such as above, the toner particles can have moderate hydrophobicity.

Note that the alumina particles may each further include an additional layer in addition to the conductive layer and the surface treatment layer. The conductive layer may cover the base directly or indirectly. The surface treatment layer may cover the conductive layer directly or indirectly. Furthermore, each of the conductive layer and the surface treatment layer is preferably a single layer but may each be a multilayer.

<Organic Particles>

In a case in which the toner according to the present embodiment is used as a one-component developer, the toner particles form a toner layer (toner chain) supported through magnetic binding force on a development roller. Provision of the organic particles as an external additive fluidizes the toner chain when the toner chain passes through the nip part between the development roller and a restricting member to promote replacement of the toner particles, thereby increasing developability of the toner.

In order to fluidize the toner chain when the toner chain passes through the nip part between the development roller and the restricting member for promotion of replacement of the toner particles, the number average primary particle diameter of the organic particles is preferably at least 30 nm and no greater than 80 nm, and more preferably at least 35 nm and no greater than 75 nm.

Preferably, the organic particles are resin particles. The resin constituting the resin particles is preferably acrylic resin or styrene-acrylic resin, and more preferably acrylic resin. The acrylic resin is a polymer of at least one acrylic acid-based monomer.

Examples of the acrylic acid-based monomer include (meth)acrylic acid, (meth)acrylamide, (meth)acrylonitrile, (meth)acrylic acid alkyl ester, (meth)acrylic acid hydroxyalkyl ester, and alkylene glycol di(meth)acrylate. Examples of the (meth)acrylic acid alkyl ester include methyl (meth)acrylate, ethyl (meth)acrylate, n-propyl (meth)acrylate, isopropyl (meth)acrylate, n-butyl (meth)acrylate, isobutyl (meth)acrylate, and 2-ethylhexyl (meth)acrylate. Examples of the (meth)acrylic acid hydroxyalkyl ester include 2-hydroxyethyl (meth)acrylate, 3-hydroxypropyl (meth)acrylate, 2-hydroxypropyl (meth)acrylate, and 4-hydroxybutyl (meth)acrylate. An example of the alkylene glycol di(meth)acrylate is ethylene glycol di(meth)acrylate.

The acrylic acid-based monomer is preferably (meth)acrylic acid alkyl ester or alkylene glycol di(meth)acrylate, more preferably methyl (meth)acrylate, n-butyl (meth)acrylate, or ethylene glycol di(meth)acrylate, and further preferably methyl methacrylate, n-butyl acrylate, or ethylene glycol dimethacrylate.

The amount of the organic particles is preferably at least 0.1 parts by mass and no greater than 10 parts by mass relative to 1000 parts by mass of the toner mother particles, and more preferably at least 0.1 parts by mass and no greater than 5 parts by mass. The amount of the organic particles is preferably at least 1 part by mass and no greater than 10 parts by mass relative to 100 parts by mass of the external additive, and more preferably at least 1 part by mass and no greater than 5 parts by mass. In a case in which the external additive further includes silica particles in addition to the organic particles, the amount of the organic particles is preferably at least 0.1 parts by mass and no greater than 10 parts by mass relative to 10 parts by mass of the silica particles, and more preferably at least 0.1 parts by mass and no greater than 5 parts by mass.

<Silica Particles>

Examples of the silica particles include fumed silica and wet silica (specific examples include sol-gel silica and silica produced by the precipitation method). Either or both hydrophobicity and positively chargeability may be imparted to the surfaces of the silica particles using a surface treatment agent. Examples of the surface treatment agent include silane coupling agents (specific examples include 3-aminopropyltrimethoxysilane), silazane compounds (specific examples include a chain silazane compound and a cyclic silazane compound), polysiloxanes (specific examples include dimethylpolysiloxane), and silicon oils (specific examples include dimethyl silicone oil).

The amount of the silica particles is preferably at least 1 part by mass and no greater than 100 parts by mass relative to 1000 parts by mass of the toner mother particles, and more preferably at least 1 part by mass and no greater than 20 parts by mass. The amount of the silica particles is preferably at least 30 parts by mass and no greater than 60 parts by mass relative to 100 parts by mass of the external additive, and more preferably at least 45 parts by mass and no greater than 55 parts by mass.

<Additional External Additive>

Examples of the additional external additive particles include particles of titanium oxide, particles of magnesium oxide, particles of zinc oxide, and particles of organic compounds such as fatty acid metal salt (specific examples include zinc stearate).

[Toner Mother Particles]

The toner mother particles contain a binder resin and a magnetic powder. The toner mother particles may further contain a releasing agent and a charge control agent as necessary. From the viewpoint of formation of favorable images, the toner mother particles preferably have a volume median diameter (D₅₀) of at least 4 μm and no greater than 9 μm. The toner mother particles may be non-capsule toner particles including no shell layers. Alternatively, the toner mother particles may be capsule toner particles including shell layers. The toner mother particles of the capsule toner particles each include a toner core containing for example a binder resin and a magnetic powder and a shell layer covering the surface of the toner core. The following describes the binder resin, the magnetic powder, the releasing agent, and the charge control agent.

<Binder Resin>

The toner mother particles contain a binder resin as a main component, for example. From the viewpoint of provision of a toner with excellent low-temperature fixability, the toner mother particles preferably contain a thermoplastic resin as the binder resin, and more preferably contain a thermoplastic resin at a percentage content of at least 85% by mass of the total of the binder resin. Examples of the thermoplastic resin include styrene resin, acrylic acid ester-based resin, olefin-based resins (specific examples include polyethylene resin and polypropylene resin), vinyl resins (specific examples include vinyl chloride resin, polyvinyl alcohol, vinyl ether resin, and N-vinyl resin), polyester resin, polyamide resin, and urethane resin. Alternatively, a copolymer of any of these resins, that is, a copolymer in which any repeating unit has been introduced in any of the above resins (specific examples include styrene-acrylic resin and styrene butadiene resin) can be used as the binder resin. The binder resin is preferably polyester resin or styrene-acrylic resin.

The polyester resin has a mass average molecular weight of preferably at least 3000 and no greater than 150,000, and more preferably at least 3000 and no greater than 10,000. The polyester resin preferably has an acid value of at least 5.0 mgKOH/g and no greater than 15.0 mgKOH/g. The polyester resin preferably has a softening point of at least 90.0° C. and no greater than 130.0° C. The polyester resin preferably has a glass transition point of at least 50.0° C. and no greater than 60.0° C. Examples of the polyester resin include a non-cross-linked polyester resin not cross-linked through a cross-linking agent and a cross-linked polyester resin cross-linked through a cross-linking agent.

The styrene-acrylic resin has a mass average molecular weight of preferably at least 3000 and no greater than 150,000, and more preferably at least 100,000 and no greater than 130,000. The styrene-acrylic resin preferably has a softening point of at least 90.0° C. and no greater than 130.0° C. The styrene-acrylic resin preferably has a glass transition point of at least 50.0° C. and no greater than 60.0° C.

The binder resin has a percentage content to the mass of the toner mother particles of preferably at least 30% by mass and no greater than 70% by mass, and more preferably at least 40% by mass and no greater than 60% by mass.

<Magnetic Powder>

Examples of the material of the magnetic powder include ferromagnetic metals (specific examples include iron, cobalt, nickel, and alloys containing one or more of these metals), ferromagnetic metal oxides (specific examples include ferrite, magnetite, and chromium dioxide), and materials subjected to ferromagnetization (specific examples include carbon materials rendered ferromagnetic through thermal treatment).

In order to inhibit elution of a metal ion (e.g., iron ion) from the magnetic powder, the magnetic powder is preferably surface treated. Inhibition of metal ion elution from the magnetic powder can further inhibit adhesion of the toner mother particles to one another.

The magnetic powder has an electrical resistivity of preferably at least 1×10⁵ Ω·cm and no greater than 1×10⁸ Ω·cm, and more preferably at least 2×10⁵ Ω·cm and no greater than 8×10⁷ Ω·cm. The number average primary particle diameter of the magnetic powder is preferably at least 0.1 μm and no greater than 1.0 μm, and more preferably at least 0.1 μm and no greater than 0.3 μm.

From the viewpoint of formation of high-quality images, the content ratio of the magnetic powder is preferably at least 20 parts by mass and no greater than 120 parts by mass relative to 100 parts by mass of the binder resin, and more preferably at least 30 parts by mass and no greater than 50 parts by mass.

<Releasing Agent>

The releasing agent is used for the purpose of imparting hot offset resistance to the toner, for example. Examples of the releasing agent include aliphatic hydrocarbon-based waxes, oxides of aliphatic hydrocarbon-based waxes, plant-derived waxes, animal-derived waxes, mineral-derived waxes, ester waxes containing a fatty acid ester as a main component, and waxes in which part or all of a fatty acid ester has been deoxidized. Preferably, the releasing agent is a plant-derived wax. Examples of the plant-derived wax include candelilla wax, carnauba wax, Japan wax, jojoba wax, and rice wax. A preferable plant-derived wax is carnauba wax. From the viewpoint of impartment of sufficient offset resistance to the toner, the content ratio of the releasing agent is preferably at least 1 part by mass and no greater than 20 parts by mass relative to 100 parts by mass of the binder resin.

<Charge Control Agent>

The charge control agent is used for the purpose of providing a toner with further excellent charge stability or an excellent charge rise characteristic, for example. The charge rise characteristic of the toner serves as an indicator as to whether or not the toner can be charged to a specific charge level in a short period of time. As a result of the toner mother particles containing a positively chargeable charge control agent (specific examples include pyridine, nigrosine, and quaternary ammonium salt), cationicity of the toner mother particles can be increased. From the viewpoint of impartment of sufficient chargeability to the toner, the content ratio of the charge control agent is preferably at least 1 part by mass and no greater than 20 parts by mass relative to 100 parts by mass of the binder resin. However, where sufficient chargeability of the toner can be ensured, the toner mother particles may not necessarily contain a charge control agent.

<Additional Component>

The toner mother particles may further contain an additive as necessary. Furthermore, the toner mother particles may further contain a black colorant for tint adjustment as necessary.

[Toner Production Method]

A method for producing the toner according to the present embodiment includes a toner mother particle production process and an external additive addition process. The toner mother particle production process is preferably executed by the pulverization method or the aggregation method, and more preferably by the pulverization method. In the external additive addition process, the external additive including the alumina particles is attached to the surfaces of the toner mother particles. No particular limitations are placed on the method for attaching the external additive to the surfaces of the toner mother particles, and the method may for example be stirring the toner mother particles and the externa additive using for example a mixer.

The toner according to the present disclosure has been described so far. However, a toner (also referred to below as toner with different aspect) other than the above toner may be favorably used. The toner with different aspect has the following features. That is, the toner with different aspect is a toner including toner particles that each include a toner mother particle and an external additive provided on the surface of the toner mother particle. The toner mother particles contain a binder resin and a magnetic powder. The external additive includes alumina particles. The alumina particles have a number average primary particle diameter of at least 150 nm and no greater than 400 nm. The alumina particles each include a base containing alumina, a conductive layer covering the base, and a surface treatment layer covering the conductive layer. The conductive layers contain a conductive metal oxide (i.e., metal oxide with conductivity). The metal oxide contains tin and antimony. The total mass of the tin and the antimony in the metal oxide is at least 10.0 parts by mass and no greater than 50.0 parts by mass relative to 100.0 parts by mass of the bases. The surface treatment layer is a titanate coupling agent treatment layer or an aluminate coupling agent treatment layer. The features of the toner with different aspect have been described so far. The toner with different aspect can form images with desired image density and less fogging even in printing on many sheets. Note that no particular limitations are placed on the zeta potential (D-pH2) and the time constant of the toner with different aspect.

### EXAMPLES

The following describes the present embodiment further specifically using examples. However, the present disclosure is no way limited to the scope of the examples.

[Alumina Particle Preparation]

Alumina particles (A-A) to (A-I) used as external additives were prepared according to the following methods. The respective configurations of the alumina particles (A-A) to (A-I) are shown in Table 1. In preparation of these alumina particles, any of bases (X1) to (X4) prepared according to the following methods were used.

<Preparation of Bases (X1)>

Aluminum hydroxide was obtained by hydrolyzing aluminum isopropoxide. Alumina was obtained by pulverizing the aluminum hydroxide using a jet mill and baking the pulverized aluminum hydroxide at a temperature of 1170° C. Using an oscillation mill in which alumina beads with a diameter of 15 mm have been loaded, 100 parts by mass of the resultant alumina and 1 part by mass of propylene glycol being a pulverizing aid were mixed for 6 hours for pulverizing the alumina. Through the pulverizing, alumina particles (a) with a number average primary particle diameter of 0.2 μm were obtained. Using a ball mill in which 700 parts by mass of alumina beads with a diameter of 2 mm have been loaded, 20 parts by mass of the alumina particles (a) and 80 parts by mass of an aqueous solution (pH=2) of aluminum chloride were mixed for 24 hours to obtain an alumina slurry (b). Next, pure water was added to 241.3 g of aluminum chloride hexahydrate (AlCl₃.6H₂O, product of Wako Pure Chemical Industries, Ltd.) to obtain an aluminum chloride solution (c) with a volume of 1 L. Into a vessel, 250 mL of the aluminum chloride solution (c) and 7.1 g of the alumina slurry (b) were added. While the vessel contents were stirred at 25° C., 39.3 g of 25% ammonia water (product of Wako Pure Chemical Industries, Ltd.) was supplied into the vessel at a supply rate of 4 g/min. using a micro rotary pump. After completion of the supply, the vessel contents became a slurry (d) in which aluminum hydrolysate has been precipitated. The slurry (d) had a pH of 3.8. The slurry (d) was left to stand at 25° C. for gelation to obtain a gelled product. Moisture in the gelled product was evaporated using a constant temperature bath at 60° C. to obtain aluminum hydrolysis in a dry powder state. The aluminum hydrolysis was ground using a mortar to obtain a ground product. The ground product was put in an alumina crucible. The ground product put in the alumina crucible was heated up to 920° C. from the room temperature at a heating rate of 300° C./hour. and baked at 920° C. for 3 hours using a box-shaped electric furnace in the atmosphere. Through the above, bases (X1) being untreated alumina particles (alumina particles subjected to neither conductive treatment nor surface treatment) were obtained.

<Preparation of Bases (X2)>

The bases (X2) were prepared according to the same method as that for preparing the bases (X1) in all aspects other than that the alumina beads with a diameter of 15 mm were changed to alumina beads with a diameter of 5 mm.

<Preparation of Bases (X3)>

The bases (X3) were prepared according to the same method as that for preparing the bases (X1) in all aspects other than that the 3-hour baking was changed to 1-hour baking and that the alumina beads with a diameter of 15 mm were changed to alumina beads with a diameter of 5 mm.

<Preparation of Bases (X4)>

The bases (X4) were prepared according to the same method as that for preparing the bases (X1) in all aspects other than that the 3-hour baking was changed to 5-hour baking.

<Preparation of Alumina Particles (A-A)>

(Conductive Treatment)

Using a homomixer “MARK II Type 2.5” produced by PRIMIX Corporation, 100.0 g of the bases (X1) were dispersed in 1 L of water to obtain a dispersion (e). In 100 mL of separately prepared 2N hydrochloric acid, 11.6 g of stannic chloride pentahydrate (SnCl₄.5H₂O) being a conductive treatment agent was dissolved to obtain a solution (f). Thereafter, the dispersion (e) was added into a vessel and heated to 70° C. The solution (f) and 12 g of an aqueous solution of 5N ammonia were dripped in parallel into the heated dispersion (e) over 40 minutes. In the parallel dripping, the liquid in the vessel was kept at 70° C. and the amount of dripping was adjusted so that the pH of the liquid in the vessel was kept at at least 7 and no greater than 8. In 450 mL of separately prepared 2N hydrochloric acid, 37.9 g of antimony trichloride (SbCl₃) being a conductive treatment agent and 5.4 g of stannic chloride pentahydrate (SnCl₄.5H₂O) being a conductive treatment agent were dissolved to obtain a solution (g). Into the liquid obtained by the parallel dripping into the vessel over 40 minutes, the solution (g) and 12 g of 5N ammonia aqueous solution were further dripped in parallel over 1 hour. In the parallel dripping, the liquid in the vessel was kept at 70° C. and the amount of dripping was adjusted so that the pH of the liquid in the vessel was kept at at least 7 and no greater than 8. Thereafter, the liquid in the vessel was filtered to obtain a residue. Water was added to the residue and re-filtered to obtain a wet cake of conductive treatment alumina. The wet cake of the conductive treatment alumina was dried at 110° C. for 12 hours to obtain a dry powder. The dry powder was baked for 1 hour in a nitrogen gas air flow at a flow rate of 1 L/min. using an electric furnace at 500° C. Through the above, conductive treatment bases (bases covered with conductive layers) were obtained. The conductive treatment bases had a volume specific resistance of 1.3 Ω·cm.

(Surface Treatment)

Using a ball mill, 50.0 g of the resultant conductive treatment bases, 2.5 g of a titanate coupling agent (“PLENACT (registered Japanese trademark) TTS”, product of Ajinomoto Co., Inc., isopropyltriisostearoyl titanate) being a surface treatment agent, and 40 mL of toluene were mixed for 2 hours to obtain a slurry. The slurry was dried at 110° C. for 12 hours to obtain a dried product. The dried product was pulverized at a pulverizing pressure of 0.6 MPa using a pulverizer. Through the above, alumina particles (A-A) were obtained. The alumina particles (A-A) had a number average primary particle diameter of 250 nm.

<Preparation of Alumina Particles (A-B) to (A-I)>

Alumina particles (A-B) to (A-I) were prepared according to the same method as that for preparing the alumina particles (A-A) in all aspects other than the following changes.

In preparation of the alumina particles (A-B), the bases (X1) were changed to the bases (X2).

In preparation of the alumina particles (A-C), the surface treatment agent was changed from the titanate coupling agent (“PLENACT (registered Japanese trademark) TTS”, product of Ajinomoto Co., Inc.) to an aluminate coupling agent (“PLENACT (registered Japanese trademark) AL-M”, product of Ajinomoto Co., Inc., aluminum alkyl acetoacetate diisporopylate).

In preparation of the alumina particles (A-D), the total amount of the added stannic chloride pentahydrate was changed from 17.0 g to 8.5 g. Furthermore, the amount of the added antimony trichloride was changed from 37.9 g to 18.0 g.

In preparation of the alumina particles (A-E), the total amount of the added stannic chloride pentahydrate was changed from 17.0 g to 3.4 g. Furthermore, the amount of the added antimony trichloride was changed from 37.9 g to 7.6 g.

In preparation of the alumina particles (A-F), the total amount of the added stannic chloride pentahydrate was changed from 17.0 g to 42.5 g. Furthermore, the amount of the added antimony trichloride was changed from 37.9 g to 94.8 g.

In preparation of the alumina particles (A-G), the surface treatment agent was changed from 2.5 g of the titanate coupling agent (“PLENACT (registered Japanese trademark) TTS”, product of Ajinomoto Co., Inc.) to 0.7 g of 3-aminopropyltrimethoxysilane (product of Shin-Etsu Chemical Co., Ltd.) and 0.3 g of hexamethyldisilazane.

In preparation of the alumina particles (A-H), the bases (X1) were changed to the bases (X3).

In preparation of the alumina particles (A-I), the bases (X1) were changed to the bases (X4).

[Organic Particle Preparation]

Organic particles (O-A) and (O-B) each used as an external additive were prepared according to the following methods.

<Preparation of Organic Particles (O-A)>

Into a flask equipped with a dropping funnel, a stirrer, a nitrogen gas inlet tube, a thermometer, and a reflux cooling pipe, 200 g of ion exchange water and 3 g of sodium lauryl sulfate were added. The flask contents were heated up to 80° C. in a nitrogen gas atmosphere. While the temperature of the flask contents was kept at 80° C., 1 g of ammonium persulfate was added into the flask and a monomer mixture was further dripped thereinto over 1 hour. The monomer mixture was a mixture of 30 g of methyl methacrylate, 30 g of n-butyl acrylate, and 40 g of ethylene glycol dimethacrylate. After the dripping, the flask contents were further stirred for 1 hour to obtain a reaction liquid. The reaction liquid was cooled to the room temperature. The cooled reaction liquid was filtered using a 300-mesh sieve to obtain an emulsion containing the organic particles (O-A). The emulsion was dried, thereby obtaining the organic particles (O-A).

<Preparation of Organic Particles (O-B)>

The organic particles (O-B) were obtained according to the same method as that for preparing the organic particles (O-A) in all aspects other than that the amount of the added sodium lauryl sulfate was changed from 3 g to 10 g.

[Silica Particle Preparation]

Silica particles (S-A) to (S-C) used as external additives were prepared according to the following methods.

<Preparation of Silica Particles (S-A)>

In 200 g of toluene, 30 g of dimethylpolysiloxane (product of Shin-Etsu Chemical Co., Ltd.), and 15 g of 3-aminopropyltrimethoxysilane (product of Shin-Etsu Chemical Co., Ltd.) were dissolved to obtain a solution. The resultant solution was diluted 10 times with toluene to obtain a diluted solution. The diluted solution was gradually dripped into 200 g of fumed silica (“AEROSIL (registered Japanese trademark) 130”, product of Nippon Aerosil Co., Ltd.) over 10 minutes under stirring of the fumed silica at a stirring speed of 120 rpm. The fumed silica with the diluted solution dripped therein was stirred at a stirring speed of 120 rpm for 30 minutes under ultrasonic irradiation to obtain a mixture. An ultrasonic cleaner (“US-30D”, product of SND Co., Ltd.) was used for the ultrasonic irradiation. The ultrasonic irradiation was carried out under conditions of an output of 850 W and a frequency of 38 kHz. The resultant mixture was heated using a constant temperature bath at 150° C. Toluene was evaporated from the mixture using a rotary evaporator to obtain a solid. The solid was dried using a reduced pressure dryer at a set temperature of 50° C. until the solid no longer lost weight to obtain a dried product. The dried product was heated at 200° C. for 3 hours under a nitrogen flow using an electric furnace to obtain a coarse powder. The coarse powder was pulverized using a jet mill and collected using a bag filter to obtain silica particles (S-A).

<Preparation of Silica Particles (S-B)>

The silica particles (S-B) were obtained according to the same method as that for preparing the silica particles (S-A) in all aspects other than that 200 g of the fumed silica (“AEROSIL (registered Japanese trademark) 130”, product of Nippon Aerosil Co., Ltd.) was changed to 150 g of wet silica (“E-220A”, product of TOSOH SILICA CORPORATION, silica produced by the precipitation method).

<Preparation of Silica Particles (S-C)>

The silica particles (S-C) were prepared according to the same method as that for preparing the silica particles (S-A) in all aspects other than that 200 g of the fumed silica (“AEROSIL (registered Japanese trademark) 130”, product of Nippon Aerosil Co., Ltd.) was changed to 150 g of wet silica (“QSG-30”, product of Shin-Etsu Chemical Co., Ltd., silica produced by the sol-gel method).

[Toner Preparation]

Toners (TA-1) to (TA-9) and (TB-1) to (TB-6) were prepared according to the following methods.

<Preparation of Toner (TA-1)>

(Toner Mother Particle Preparation)

Using an FM mixer (“FM-20B”, product of Nippon Coke & Engineering Co., Ltd.), a mixture was obtained by mixing 1100 g of polyester resin A (product of Kao Corporation, non-cross-linked polyester resin, Mw: 6500, acid value: 8.2 mgKOH/g, Tm: 96.3° C., Tg: 54.4° C.) as a binder resin, 1090 g of polyester resin B (product of Kao Corporation, cross-linked polyester resin, Mw: unmeasurable due to being cross-linked polyester resin, acid value: 11.8 mgKOH/g, Tm: 118.5° C., Tg: 59.6° C., gel component concentration: 36% by mass) as a binder resin, 1450 g of a magnetic powder (“MRO-15A”, product of TODA KOGYO CORP., electric resistivity: 2×10⁵ Ω·cm), 200 g of a charge control agent (“FCA-482PLV”, product of Fujikura Kasei Co., Ltd.), and 160 g of a carnauba wax (“CARNAUBA WAX No. 1”, product of S. KATO & CO.) as a releasing agent at 200 rpm for 5 minutes.

The resultant mixture was melt-kneaded using a twin screw extruder (“TEM-265S”, product of Toshiba Machine Co. Ltd.) under conditions of a cylinder temperature of 120° C., a shaft rotational speed of 100 rpm, and a flow rate of 75 g/min. The resultant melt-kneaded product was cooled. The cooled melt-kneaded product was coarsely pulverized using a pulverizer (“ROTOPLEX (registered Japanese trademark) Type 16/8”, product of former TOA KIKAI SEISAKUSHO) to obtain a coarsely pulverized product. The coarsely pulverized product was finely pulverized using a pulverizer (TRUBO MILL Type TA″, product of FREUND-TURBO CORPORATION) to obtain a finely pulverized product. The finely pulverized product was loaded into a jet mill (“MJT-1”, product of Hosokawa Micron Corporation), and classified under further pulverization. Toner mother particles were obtained in the manner described above.

(External Additive Addition)

Using an FM mixer (“FM-10”, product of Nippon Coke & Engineering Co., Ltd.), 1 kg of the resultant toner mother particles, 11 g of the silica particles (S-A) as an external additive, 10 g of the alumina particles (A-A) as an external additive, and 1 g of the organic particles (O-A) as an external additive were mixed for 5 minutes at a rotational speed of 3500 rpm. The external additives were attached to the toner mother particles in the manner described above. The toner mother particles with the external additives attached thereto were sifted using a 100-mesh sieve (opening 150 μm) to obtain a toner (TA-1).

<Preparation of Toners (TA-2) to (TA-8), (TB-1), (TB-2), and (TB-4) to (TB-6)>

Toners (TA-2) to (TA-8), (TB-1), (TB-2), and (TB-4) to (TB-6) were obtained according to the same method as that for preparing the toner (TA-1) in all aspects other than that the binder resins, the magnetic powders, the silica particles, the alumina particles, and the organic particles shown in Table 2 were used.

<Preparation of Toner (TA-9)>

A toner (TA-9) was obtained according to the same method as that for preparing the toner (TA-1) in all aspects other than that 1100 g of the polyester resin A and 1090 g of the polyester resin B were changed to 2190 g of styrene-acrylic resin C (“Tiz-524”, product of Fujikura Kasei Co., Ltd., Mw: 117,000, Tm: 119.0° C., Tg: 55.9° C.).

<Preparation of Toner (TB-3)>

A toner (TB-3) was obtained according to the same method as that for preparing the toner (TA-1) in all aspects other than that no alumina particles were used.

[Measurement]

<Measurement of Number Average Primary Particle Diameter>

Using a scanning electron microscope (“JSM-6700F”, product of JEOL Ltd.), a cross-sectional image (magnification: 30,000×) of each toner was captured. An equivalent circle diameter of 100 external additive particles (specifically, any of the alumina particles (A-A) to (A-I) and the organic particles (O-A) and (O-B)) were analyzed based on the captured cross-sectional image using image analysis software (“WinROOF”, product of MITANI CORPORATION), and the average value thereof was taken to be a number average primary particle diameter of the external additive particles. Table 2 shows the number average primary particle diameters of the alumina particles (A-A) to (A-I) and the organic particles (O-A) and (O-B).

<Measurement of Zeta Potential>

Zeta potential measurement was carried out in an environment at a temperature of 20° C. A surfactant aqueous solution at a concentration of 10% by mass was prepared by mixing 10 parts by mass of a nonionic surfactant (“EMULGEN (registered Japanese trademark) 120”, product of Kao Corporation, component: polyoxyethylene lauryl ether, HLB value: 15.3) and 90 parts by mass of ion exchange water. To 2 mL of the surfactant aqueous solution, 20 mg of a measurement target (specifically, any of the toners (TA-1) to (TA-9) and (TB-1) to (TB-6)) was added. Then, ultrasonic irradiation of the resultant mixture was carried out to obtain a dispersion of the toner. The ultrasonic irradiation was carried out for 1 minute under conditions of a frequency of 40 kHz and an output of 500 W. The dispersion of the toner was diluted 50 times with ion exchange water to obtain a diluted dispersion of the toner. Using a neodymium magnet (residual magnetic flux density: 1.25 T), the diluted dispersion of the toner was separated by magnetic force into a sediment attracted by the magnet and a supernatant not attracted by the magnet. The separated supernatant was taken to be a measurement liquid (L-U).

The separated sediment was added to 2 mL of the surfactant aqueous solution and ultrasonic irradiation was carried out to obtain a dispersion of the sediment. The ultrasonic irradiation was carried out for 1 minute under conditions of a frequency of 40 kHz and an output of 500 W. The dispersion of the sediment was diluted 50 times with ion exchange water to obtain a diluted dispersion of the sediment. The resultant diluted dispersion of the sediment was taken to be a measurement liquid (L-D).

The pH of the measurement liquid (L-U) was adjusted using an aqueous solution of 0.1N sodium hydroxide and an aqueous solution of 0.1N nitric acid to obtain the measurement liquid (L-U) with pH 2 and the measurement liquid (L-U) with pH 5. Also, the pH of the measurement liquid (L-D) was adjusted using an aqueous solution of 0.1N sodium hydroxide and an aqueous solution of 0.1N nitric acid to obtain the measurement liquid (L-D) with pH 2 and the measurement liquid (L-D) with pH 5. The zeta potential of each measurement liquid (specifically, the measurement liquid (L-U) with pH 2, the measurement liquid (L-U) with pH 5, the measurement liquid (L-D) with pH 2, and the measurement liquid (L-D) with pH 5) was measured using a laser Doppler zeta potential analyzer (“ELSZ-1000”, product of Otsuka Electronics Co., Ltd.) to plot a zeta potential distribution. The zeta potential distribution was plotted in a graph with zeta potential (unit: mV) on the horizontal axis and intensity on the vertical axis. From the zeta potential distribution, a value (peak value) and a half-width of the zeta potential of the measurement liquid were determined.

The values and the half-widths of the zeta potentials at pH 2 of the measurement liquids (L-D) are respectively shown in the columns “Value” and “Half-width” under “pH 2” under “Sediment” in Table 3. The values and the half-widths of the zeta potentials at pH 5 of the measurement liquids (L-D) are respectively shown in the columns “Value” and “Half-width” under “pH 5” under “Sediment” in Table 3. The values and the half-widths of the zeta potentials at pH 2 of the measurement liquids (L-U) are respectively shown in the columns “Value” and “Half-width” under “pH 2” under “Supernatant” in Table 3. The values and the half-widths of the zeta potentials at pH 5 of the measurement liquids (L-U) are respectively shown in the columns “Value” and “Half-width” under “pH 5” under “Supernatant” in Table 3.

<Measurement of Time Constant>

Time constant measurement was carried in an environment at a temperature of 20° C. and a relative humidity of 65%. First, 20 mg of a measurement target (specifically, any of the toners (TA-1) to (TA-9) and (TB-1) to (TB-6)) was nipped between electrodes (“Type SE-43”, product of Ando Electric Co., Ltd., powder electrodes). Then, a load of 40 kgf/cm² was applied thereto to pelletize (to a thickness of 100 μm) the measurement target. Next, a frequency response analyzer (“Type 1260”, product of Solartron Analytical) was connected to each end of the above electrodes. Then, an electrical characteristic of the measurement sample was measured using the frequency response analyzer to generate a Cole-Cole plot. The electrical characteristic was measured under measurement conditions of a voltage (Vpp) from a maximum voltage to a minimum voltage of 1 V, a frequency of 100 kHz to 40 Hz (5 pt/decade), and a number of times of the measurement of 3 cycles. Subsequently, the electrical resistance and the permittivity of the measurement target were measured by carrying out fitting with the measurement target regarded as an equivalent parallel resistor-capacitor (RC) circuit. Thereafter, a time constant [sec] (product of electric resistance and permittivity) was calculated based on the electric resistance and the permittivity of the measurement target. The calculated time constants of the measurement targets are shown in Table 3.

[Evaluation]

Image density and anti-fogging property of each toner were evaluated according to the following methods. The evaluation results are shown in Table 3.

<Evaluation Apparatus and Evaluation Environment>

As an evaluation apparatus, a monochrome multifunction peripheral (“TASKalfa (registered Japanese trademark) 3212i”, product of KYOCERA Document Solutions Inc.) was used. The toner was loaded into the development device of the evaluation apparatus. A toner for replenishment (specifically, the same toner as that loaded in the development device) was loaded into the toner container of the evaluation apparatus. Each evaluation was carried out in an environment (NN environment) at a temperature of 23.0° C. and a relative humidity of 50.0%.

<Image Density Evaluation>

Using the evaluation apparatus, duplex printing of an image I (image including a solid image area and a character image area with a printing rate of 1%) was carried out on 5000 sheets of paper. The reflection density (initial ID) of the solid image area of the first printed image I (image I printed first on the obverse side of the first sheet) was measured. Also, the reflection density (post-printing ID) of the solid image area of the last printed image I (image I printed last on the reverse side of the 5000th sheet) was measured. The reflection densities were measured using a white-light photometer (“TC-6DX”, product of Tokyo Denshoku Co., Ltd.). Each image density was evaluated according to the following criteria.

(Criteria of Image Density Evaluation)

Good: ID of at least 1.20

Poor: ID of less than 1.20

<Anti-Fogging Property Evaluation>

After the above-described evaluation in <Image Density Evaluation>, an image II (character image with a printing rate of 5%) was printed on 1000 sheets of paper using the evaluation apparatus. With respect to each of the printed sheets, a reflection density X of a non-printed area (blank area) was measured using a white-light photometer (“TC-6DX”, product of Tokyo Denshoku Co., Ltd.). Also, a reflection density Y of a non-printed sheet of the paper was measured using the white-light photometer (“TC-6DX”, product of Tokyo Denshoku Co., Ltd.). With respect to each of the printed sheets, a fogging density was calculated using an equation “(fogging density)=(reflection density X)−(reflection density Y)”, and the maximum value thereof was taken to be an evaluation value (FD) of fogging density. Anti-fogging property was evaluated based on the following criteria.

(Criteria of Anti-Fogging Property Evaluation)

Good: FD of no greater than 0.008

Poor: FD of greater than 0.008

Note that the terms in Tables 1 to 3 mean as follows.
SnCl₄.5H₂O: stannic chloride pentahydrate
SbCl₃: antimony trichloride
Sn under column “Conversion rate”: mass of tin (Sn) contained in metal oxide obtained in reaction of stannic chloride pentahydrate with a percentage yield of 100%. The mass of tin was calculated using an equation “(mass of tin)=(amount of added stannic chloride pentahydrate)×(atomic weight of tin)/(formula weight of stannic chloride pentahydrate)=(amount of added stannic chloride pentahydrate)×118.7/350.5”.
Sb under column “Conversion rate”: mass of antimony (Sb) contained in metal oxide obtained in reaction of antimony trichloride with a percentage yield of 100%. The mass of antimony was calculated using an equation “(mass of antimony)=(amount of added antimony trichloride)×(atomic weight of antimony)/(formula weight of antimony trichloride)=(amount of added antimony trichloride)×121.8/228.1”.
Sn+Sb under column “Conversion rate”: total mass of tin and antimony in metal oxide (sum of value of Sn under column “Conversion rate” and value of Sb under column “Conversion rate”)
TTS: titanate coupling agent (“PLENACT (registered Japanese trademark) TTS”, product of Ajinomoto Co., Inc., isopropyltriisostearoyl titanate)
AL-M: aluminate coupling agent (“PLENACT (registered Japanese trademark) AL-M”, product of Ajinomoto Co., Inc., aluminum alkyl acetoacetate diisporopylate)
AS: 3-aminopropyltrimethoxysilane
HDS: hexamethyldisilazane
PES: polyester resin A and polyester resin B
SA: styrene-acrylic resin C
MRO-15A: magnetic powder (“MRO-15A”, product of TODA KOGYO CORP., electrical resistivity: 2×10⁵ Ω·cm)
MTS-D3: magnetic powder (“MTS-D3”, product of TODA KOGYO CORP., electrical resistivity: 8×10⁷ Ω·cm)
Silica: silica particles
Alumina: alumina particles
Organic: organic particles
Diameter: number average primary particle diameter
NG: poor

TABLE 1

| | Conductive treatment | | | | | | | | | |
|---|---|---|---|---|---|---|---|---|---|---|
| | | | Conductive treatment agent | | | | | Surface treatment | | |
| Alumina | Base | | Amount [g] | | Conversion rate [g] | | | Conductive treatment base | Surface treatment agent | |
| particles | Type | Amount [g] | SnCl₄•5H₂O | SbCl₃ | Sn | Sb | Sn + Sb | Amount [g] | Type | Amount [g] |
| A-A | X1 | 100.0 | 17.0 | 37.9 | 5.8 | 20.2 | 26.0 | 50.0 | TTS | 2.5 |
| A-B | X2 | 100.0 | 17.0 | 37.9 | 5.8 | 20.2 | 26.0 | 50.0 | TTS | 2.5 |
| A-C | X1 | 100.0 | 17.0 | 37.9 | 5.8 | 20.2 | 26.0 | 50.0 | AL-M | 2.5 |
| A-D | X1 | 100.0 | 8.5 | 18.0 | 2.9 | 9.6 | 12.5 | 50.0 | TTS | 2.5 |
| A-E | X1 | 100.0 | 3.4 | 7.6 | 1.2 | 4.1 | 5.2 | 50.0 | TTS | 2.5 |
| A-F | X1 | 100.0 | 42.5 | 94.8 | 14.4 | 50.6 | 65.0 | 50.0 | TTS | 2.5 |
| A-H | X3 | 100.0 | 17.0 | 37.9 | 5.8 | 20.2 | 26.0 | 50.0 | TTS | 2.5 |
| A-I | X4 | 100.0 | 17.0 | 37.9 | 5.8 | 20.2 | 26.0 | 50.0 | TTS | 2.5 |
| A-G | X1 | 100.0 | 17.0 | 37.9 | 5.8 | 20.2 | 26.0 | 50.0 | AS | 0.7 |
| | | | | | | | | | HDS | 0.3 |

TABLE 2

| | | | | External additive | | | | |
|---|---|---|---|---|---|---|---|---|
| | | Toner mother particles | | | Alumina | | Organic | |
| | | Binder | Magnetic | | | Diameter | | Diameter |
| | Toner | resin | powder | Silica | Type | [nm] | Type | [nm] |
| Example 1 | TA-1 | PES | MRO-15A | S-A | A-A | 250 | O-A | 75 |
| Example 2 | TA-2 | PES | MRO-15A | S-A | A-B | 350 | O-A | 75 |
| Example 3 | TA-3 | PES | MRO-15A | S-A | A-C | 250 | O-A | 75 |
| Example 4 | TA-4 | PES | MRO-15A | S-A | A-D | 250 | O-A | 75 |
| Example 5 | TA-5 | PES | MRO-15A | S-A | A-A | 250 | O-B | 35 |
| Example 6 | TA-6 | PES | MTS-D3 | S-A | A-A | 250 | O-A | 75 |
| Example 7 | TA-7 | PES | MRO-15A | S-B | A-A | 250 | O-A | 75 |
| Example 8 | TA-8 | PES | MRO-15A | S-C | A-A | 250 | O-A | 75 |
| Example 9 | TA-9 | SA | MRO-15A | S-A | A-A | 250 | O-A | 75 |
| Comparative Example 1 | TB-1 | PES | MRO-15A | S-A | A-E | 250 | O-A | 75 |
| Comparative Example 2 | TB-2 | PES | MRO-15A | S-A | A-F | 250 | O-A | 75 |
| Comparative Example 3 | TB-3 | PES | MRO-15A | S-A | None | None | O-A | 75 |
| Comparative Example 4 | TB-4 | PES | MRO-15A | S-A | A-H | 100 | O-A | 75 |
| Comparative Example 5 | TB-5 | PES | MRO-15A | S-A | A-I | 450 | O-A | 75 |
| Comparative Example 6 | TB-6 | PES | MRO-15A | S-A | A-G | 250 | O-A | 75 |

TABLE 3

| | | Zeta potential | | | | | | | | | | | |
|---|---|---|---|---|---|---|---|---|---|---|---|---|---|
| | | Sediment | | | | Supernatant | | | | | Evaluation | | |
| | | pH 2 | | pH 5 | | pH 2 | | pH 5 | | Time | ID | | |
| | | Value | Half-width | Value | Half-width | Value | Half-width | Value | Half-width | constant | | Post- | |
| | Toner | [mV] | [mV] | [mV] | [mV] | [mV] | [mV] | [mV] | [mV] | [second] | Initial | printing | FD |
| Example 1 | TA-1 | 8.7 | 23.5 | −40.2 | 22.1 | 8.5 | 24.4 | −40.2 | 21.1 | 2.3 | 1.34 | 1.35 | 0.003 |
| Example 2 | TA-2 | 5.3 | 22.3 | −48.3 | 20.4 | 9.2 | 21.1 | −43.4 | 20.1 | 2.1 | 1.37 | 1.31 | 0.004 |
| Example 3 | TA-3 | 8.9 | 26.4 | −44.6 | 22.3 | 6.6 | 25.7 | −46.5 | 26.8 | 2.2 | 1.35 | 1.32 | 0.004 |
| Example 4 | TA-4 | 14.5 | 25.1 | −38.3 | 22.4 | 14.9 | 27.9 | −37.5 | 22.9 | 5.8 | 1.32 | 1.28 | 0.002 |
| Example 5 | TA-5 | 11.5 | 27.9 | −38.5 | 24.3 | 7.6 | 25.6 | −38.3 | 23.8 | 2.5 | 1.32 | 1.29 | 0.003 |
| Example 6 | TA-6 | 7.3 | 23.3 | −40.6 | 21.1 | 8.3 | 24.2 | −40.2 | 21.3 | 4.2 | 1.37 | 1.34 | 0.005 |
| Example 7 | TA-7 | 10.1 | 25.1 | −44.1 | 22.4 | 10.3 | 24.4 | −43.6 | 24.5 | 2.9 | 1.42 | 1.27 | 0.003 |
| Example 8 | TA-8 | 8.1 | 25.6 | −44.5 | 23.1 | 7.9 | 24.1 | −44.9 | 23.8 | 2.6 | 1.37 | 1.39 | 0.007 |
| Example 9 | TA-9 | 10.2 | 24.6 | −37.9 | 25.8 | 10.2 | 24.6 | −38.3 | 25.7 | 1.9 | 1.41 | 1.38 | 0.003 |
| Comparative | TB-1 | 18.3 | 20.1 | −33.1 | 24.8 | 19.5 | 26.6 | −32.3 | 24.6 | 13.2 | 1.32 | 1.10 | 0.003 |
| Example 1 | | | | | | | | | | | | (NG) | |
| Comparative | TB-2 | 5.1 | 25.6 | −42.3 | 21.7 | 5.5 | 14.4 | −41.5 | 22.3 | 0.7 | 1.43 | 1.31 | 0.013 |
| Example 2 | | | | | | | | | | | | | (NG) |
| Comparative | TB-3 | −2.2 | 29.5 | −62.4 | 27.7 | 0.2 | 28.8 | −50.3 | 28.5 | 2.0 | 1.29 | 1.04 | 0.003 |
| Example 3 | | | | | | | | | | | | (NG) | |
| Comparative | TB-4 | 11.3 | 22.4 | −37.0 | 24.5 | 9.8 | 23.3 | −35.2 | 24.6 | 1.8 | 1.31 | 0.88 | 0.006 |
| Example 4 | | | | | | | | | | | | (NG) | |
| Comparative | TB-5 | 3.2 | 24.2 | −48.7 | 25.5 | 8.8 | 24.5 | −39.1 | 25.1 | 4.3 | 1.29 | 0.94 | 0.004 |
| Example 5 | | | | | | | | | | | | (NG) | |
| Comparative | TB-6 | 23.6 | 22.3 | −25.2 | 23.1 | 17.2 | 23.3 | −30.9 | 23.9 | 2.8 | 1.39 | 1.13 | 0.015 |
| Example 6 | | | | | | | | | | | | (NG) | (NG) |

As shown in Table 3, the time constant of the toner (TB-1) was greater than 10.0 seconds. As shown in Table 3, post-printing image density of the toner (TB-1) was evaluated as poor.

As shown in Table 3, the time constant of the toner (TB-2) was less than 1.0 seconds. As shown in Table 3, anti-fogging property of the toner (TB-2) was evaluated as poor.

As shown in Table 2, the toner (TB-3) contained no alumina particles as an external additive. As shown in Table 3, the zeta potential (D-pH2) of the toner (TB-3) was less than 0.0 mV. As also shown in Table 3, post-printing image density of the toner (TB-3) was evaluated as poor.

As shown in Table 2, the alumina particles of the toner (TB-4) had a number average primary particle diameter of less than 150 nm. As shown in Table 3, post-printing image density of the toner (TB-4) was evaluated as poor.

As shown in Table 2, the alumina particles of the toner (TB-5) had a number average primary particle diameter of greater than 400 nm. As shown in Table 3, post-printing image density of the toner (TB-5) was evaluated as poor.

As shown in Table 3, the zeta potential (D-pH2) of the toner (TB-6) was greater than 20.0 mV. As shown in Table 3, post-printing image density and anti-fogging property of the toner (TB-6) were evaluated as poor.

By contrast, each of the toners (TA-1) to (TA-9) had the following features as shown in Tables 2 and 3. The external additive of the toner included alumina particles. The alumina particles had a number average primary particle diameter of at least 150 nm and no greater than 400 nm. The toner had a time constant of at least 1.0 seconds and no greater than 10.0 seconds. The zeta potential (D-pH2) was at least 0.0 mV and no greater than 20.0 mV. As shown in Table 3, both post-printing image density and anti-fogging property of each of the toners (TA-1) to (TA-9) were evaluated as good.

From the above, it would be determined that images with desired image density and less fogging can be formed with the toner of the present disclosure that encompasses the toners (TA-1) to (TA-9) even in printing on many sheets.

What is claimed is:

1. A toner comprising toner particles, wherein
the toner particles each include a toner mother particle and an external additive provided on a surface of the toner mother particle,
the toner mother particles contain a binder resin and a magnetic powder,
the external additive includes alumina particles,
the alumina particles have a number average primary particle diameter of at least 150 nm and no greater than 400 nm,
the toner has a time constant of at least 1.0 seconds and no greater than 10.0 seconds, and
a sediment has a zeta potential at pH 2 of at least 0.0 mV and no greater than 20.0 mV, the sediment being obtained by separation from a dispersion of the toner.

2. The toner according to claim 1, wherein
the alumina particles each include a base containing alumina, a conductive layer covering the base, and a surface treatment layer covering the conductive layer.

3. The toner according to claim 2, wherein
the conductive layers contain a conductive metal oxide,
the metal oxide contains tin and antimony, and
a total mass of the tin and the antimony in the metal oxide is at least 10.0 parts by mass and no greater than 50.0 parts by mass relative to 100.0 parts by mass of the bases.

4. The toner according to claim 2, wherein
the surface treatment layer is a titanate coupling agent treatment layer or an aluminate coupling agent treatment layer.

5. The toner according to claim 1, wherein
the sediment has a zeta potential at pH 5 of at least −60.0 mV and less than 0.0 mV.

6. The toner according to claim 1, wherein
a supernatant has a zeta potential at pH 2 of at least 0.0 mV and no greater than 20.0 mV, the supernatant being obtained by separation from the dispersion of the toner, and
the supernatant has a zeta potential at pH 5 of at least −60.0 mV and less than 0.0 mV.

7. The toner according to claim 1, wherein
a half-width of the zeta potential at pH 2 of the sediment, a half-width of a zeta potential at pH 5 of the sediment, a half-width of a zeta potential at pH 2 of a supernatant, and a half-width of a zeta potential at pH 5 of the supernatant each are at least 0.0 mV and no greater than 30.0 mV, the supernatant being obtained by separation from the dispersion of the toner.

8. The toner according to claim 1, wherein
the external additive further includes organic particles with a number average primary particle diameter of at least 30 nm and no greater than 80 nm.
